(19) United States
(12) Patent Application Publication
(10) Pub. No.: US 2016/0243711 A1
(43) Pub. Date: Aug. 25, 2016

(54) HAND TOOL FOR PROCESSING GOODS

(71) Applicant: A O SCHALLINOX GMBH, Schocherswil (CH)

(72) Inventor: César CARRASCO, Egnach (CH)

(73) Assignee: A O SCHALLINOX GMBH, Schocherswil (CH)

(21) Appl. No.: 15/024,399

(22) PCT Filed: Sep. 12, 2014
(86) PCT No.: PCT/EP2014/069567

§ 371 Date: Mar. 24, 2016

(30) Foreign Application Priority Data
Sep. 27, 2013 (EP) 13186554.5

(51) Int. Cl. B26B 7/00

(52) U.S. Cl. CPC B26B 7/00

(57) ABSTRACT

The hand tool includes a tool part that is held in a hollow cylindrical housing body of a housing part and that includes an ultrasonic transducer with at least one piezo element, which serves for delivering ultrasonic energy to a blade that is connected to the tool part. According to the invention a plurality of piezo elements are provided, which are separated from one another by contact elements and which include each a transfer opening, which is traversed by a transducer rod that is connected, directly or indirectly, to a coupling rod that is connected in one piece to the blade and that a pressing element is provided that is connected to the transducer rod and that presses the piezo elements against a locating surface of an element which is connected, directly or indirectly, to the coupling rod and which mechanically couples the piezo elements with the coupling rod.

The invention relates to a hand tool for processing, particularly cutting goods under the application of ultrasonic energy.

In numerous industrial applications, particularly in the food industry, products need to be provided in predetermined dimensions. Often, food products, such as bread, meat, sausages or cheese are cut in slices and are packed. For this purpose, cutting tools are used, with which the processed good is cut under the application of ultrasonic energy. Such a device is disclosed in [1], EP2551077A1. This device comprises holding devices and guiding devices, with which the cutting tools are held and guided, in order to process the goods.

[2], EP0543628A1, discloses a method for cutting food products under the application of ultrasonic energy. Thereby, ultrasonic signals in the frequency range between 10 kHz and 60 kHz and with amplitudes in the range between 20 μm and 200 μm are applied to a blade.

Often goods are processed manually. E.g., for examining the product quality cuts are made through a processed good. However, also in shops, e.g. in a bakery or at a meat market, goods, such as bread, meat or cheese, needs to be cut manually, often fine and precise, which is not possible with conventional knives, even when the processed goods are mechanically fixed.

Furthermore, in industrial processes and in the hotel and restaurant industry it is often required, to add an atomised powder to a processed good, which often is not reached as desired, wherefore the added powder is normally distributed by stirring.

[3], U.S. Pat. No. 5,695,510, discloses a surgical knife, to which ultrasonic energy is applied. However, knives of this kind cannot be used for the above described purposes.

[4], U.S. Pat. No. 6,785,970B1, discloses a knife that is oscillated by means of a motor, which however requires space and energy. Furthermore, with the mechanically oscillating knife a desired cutting quality cannot be reached.

The present invention is therefore based on the object of providing an improved hand tool, with which goods can advantageously manually be processed, particularly be cut or atomised, under the application of ultrasonic energy.

The hand tool shall have a compact structure and shall easily be manageable. In spite of this requirement, the hand tool shall allow precisely processing relatively large goods, particularly bread, meat, cheese and vegetables without effort and with little force.

The hand tool shall operate efficiently so that it can operate with an external or a local power supply unit and that it exhibits also in autonomous operation relatively little weight.

The ultrasonic energy shall be transferable practically without losses to a sonotrode. Furthermore, sufficient ultrasonic energy shall be available whenever required so that mechanically firm goods can be processed as well. Further, the hand tool shall be built with a stable structure so that mechanically firm goods can be processed over a longer period of time without the occurrence of wear.

These objects are reached with a hand tool that comprises the features defined in claim 1. Preferred embodiments of the invention are defined in further claims.

The hand tool comprises a tool part that is held in a preferably hollow cylindrical housing body of a housing part and that comprises an ultrasonic transducer with at least one piezo element, which serves for delivering ultrasonic energy to a blade that is connected to the tool part.

According to the invention a plurality of piezo elements are provided, which are separated from one another by contact elements and which comprise each a transfer opening, which is traversed by a transducer rod that is connected, directly or indirectly, to a coupling rod that is connected in one piece to the blade and that a pressing element is provided that is connected to the transducer rod and that presses the piezo elements against a locating surface of an element which is connected, directly or indirectly, to the coupling rod and which mechanically couples the piezo elements with the coupling rod.

In preferred embodiments the transducer rod
a) is a part of the coupling rod and is therefore connected in one piece with the coupling rod; or
b) is held at the front side by a press fitting or a threaded connection in an opening provided in the coupling rod; or
c) is held at the front side by a press fitting or a threaded connection in a first cylinder opening of a connecting cylinder that is connected to the coupling rod.

The connecting cylinder, if provided,
a) is part of the coupling rod and therefore connected to the coupling rod in one piece; or
b) comprises at the front side a second cylinder opening, in which a bolt that is provided on the coupling rod is held by a press fitting or a threaded connection; or
c) comprises at the front side a massive or hollow cylindrical cylinder bolt, which is held within the opening of the coupling rod by a press fitting or a threaded connection; or
d) comprises at the front side a second cylinder opening, in which a first bolt member of a connecting bolt is held by a press fitting or a threaded connection and that in the rod opening of the connecting cylinder a second bolt member of the connecting bolt is held by a press fitting or a threaded connection.

In preferred embodiments the coupling rod and the transducer rod or the coupling rod and the connecting cylinder are welded together, so that practically a unitary connection between the transducer rod and the coupling rod and possibly connecting pieces provided in therebetween, such as the connecting cylinder and the connecting bolt, results.

In preferred embodiments the transducer rod is coaxially aligned with a proximal portion of the coupling rod, so that the section of the tool part that is provided with the ultrasonic transducer can be arranged with little space requirement in a cylindrical housing body, which can be used as handle.

With all variations of the connection of the transducer rod to the coupling rod, a compact setup of the cutting tool is achieved. The transducer rod and the coupling rod preferably form a unitary metal body so that loss free coupling and an even more compact setup can be reached.

Due to the advantageous design of the tool part the ultrasonic transducer can be equipped with larger and more powerful piezo elements, preferably hollow cylindrical or annular plates and still comprise compact dimensions. The annular piezo-disks can have an outer diameter, which is a multiple of the inner diameter or of the diameter of the transducer rod, respectively, so that ultrasound waves can be transferred with high energy to the coupling rod and to the sonotrode.

In a preferred embodiment, four to ten annular piezo disks, which are separated from one another by contact elements, are held in series. The contact elements, preferably brass plates, cover the piezo elements preferably completely and comprise connecting contacts.

The piezo elements and the contact elements, which are seated on the transducer rod and which are preferably separated from the transducer rod by an insulation tube, are pressed by the pressing element against a locating surface, which is provided at the end of the connecting cylinder or of the coupling rod which is facing the ultrasonic transducer. The locating surface is preferably a annular ring area, which is congruent to the front surface of the neighbouring piezo elements. Hence, mechanical ultrasonic energy supplied by the piezo elements is transferred from the front side via the locating surface to the connecting cylinder or directly to the coupling rod and via the backside across the pressing element and the transducer rod to the connecting cylinder or directly to the coupling rod. Ultrasonic energy is therefore fed along to different paths into the coupling rod.

The transducer rod preferably comprises an external thread that holds the pressing element, which comprises an internal thread. By turning the pressing element the transducer block held between the pressing element and the locating surface can be pressed together.

The coupling rod exhibits a circular, triangular, square or polygonal cross-section that is preferably adapted to the range of the applied operating frequencies.

In preferred embodiments, temperature sensors are provided that are held in openings provided in the coupling rod, in the connecting bolt, and/or in the transducer rod. The connecting lines of the installed sensors are preferably arranged in a cable channel, which coaxially traverses the transducer rod. By means of the temperature sensors the temperatures of the coupling rod and of the transducer rod can be measured. Depending on the measured temperatures the ultrasonic generator can advantageously be controlled, in order to reduce or stop application of ultrasonic energy to the tool part during unfavourable operating conditions. This allows recognising unfavourable operating behaviour and avoiding damage on the tool part. Preferably an additional piezo element is provided, which senses oscillations on the transducer rod, on the connecting cylinder or on the coupling rod. Analysing the amplitudes of the oscillations in the given frequency ranges allows selecting optimal operating frequencies and avoiding operating frequencies, for which a sub-optimal energy transfer to the sonotrode or to the processed goods occurs.

The advantageous structure of the tool part therefore allows simple assembly of the tool part and simple integration into the housing part.

For this purpose, the transducer rod or the connecting cylinder or the coupling rod is preferably provided with or connected to an outer flange, which is held by an inner flange that extends into the cross-section of the hollow cylindrical housing body.

Furthermore, the housing body preferably comprises an internal thread, which holds a threaded element, such as a crown nut, that is provided with an external thread and that can press the outer flange provided at the tool part against the inner flange provided at the housing part. The threaded element is inserted into the hollow cylindrical housing body and is turned in the internal thread until the outer flange and the inner flange abut with a desired pressure. In preferred embodiments, an elastic element is provided between the inner flange and the outer flange, which acoustically decouples the tool part and the housing part from one another.

The inner flange is preferably provided at the front side of the housing body. Hence, the tool part is held at the front side of the housing body, wherefore at the backside, inside the housing part, ample space is available in which further device parts can be arranged. E.g., an ultrasonic generator can be arranged that is supplied with a supply voltage and that can deliver electrical ultrasound signals in the frequency range from 25 kHz up to 50 kHz. Preferably a controllable ultrasonic generator is provided that can selectively deliver the desired frequencies. Alternatively, electrical ultrasound signals can also be supplied via a connecting cable. In addition, a power supply unit, e.g. a battery or an accumulator, can be provided inside the housing body, which supply the electrical energy required for the hand tool. The supply voltage, e.g. DC-voltage, can be delivered via a connecting cable.

Inside the housing body preferably a printed circuit board with electrical and electronic modules is arranged, with which the hand tool can be controlled. The electrical modules of the ultrasonic generator can also advantageously be arranged on the printed circuit board.

Preferably a flexible printed circuit board is provided that surrounds the transducer block or the connecting cylinder at least partially. In this manner, the printed circuit board scarcely requires space and can advantageously be coupled, in preferred embodiments, with metallic elements of the tool part. Preferably an insulated metal substrate IMS is used as flexible printed circuit board, with which heat loss of the electrical and electronic modules is led away and preferably forwarded to a metal body, e.g. to the connecting cylinder.

For controlling the hand tool, preferably a control ring is provided, which surrounds the housing body and is rotatably held therefrom. By turning the control ring, which preferably comprises magnetic elements, electrical switching elements can be actuated, in order to select a desired mode of operation of the hand tool.

Inside the housing body preferably a cooling coil is arranged, through which a cooling agent can flow. For cooling purposes, the cooling coil can advantageously be connected to the metal substrate of the printed circuit board.

The coupling rod and the blade are adapted to the requirements of the user. The coupling rod extends preferably along a curve and stands with an end piece preferably perpendicularly on the back of the blade, whereby optimal coupling of ultrasonic energy results.

As required, the blade is aligned with the cutting edge forwards, to the side or backwards. Hence, the hand tool can be adapted to any working process. If required, it can be arranged that the sonotrode, i.e. the blade, can be exchanged.

Below the invention is described with reference to drawings. Thereby show:

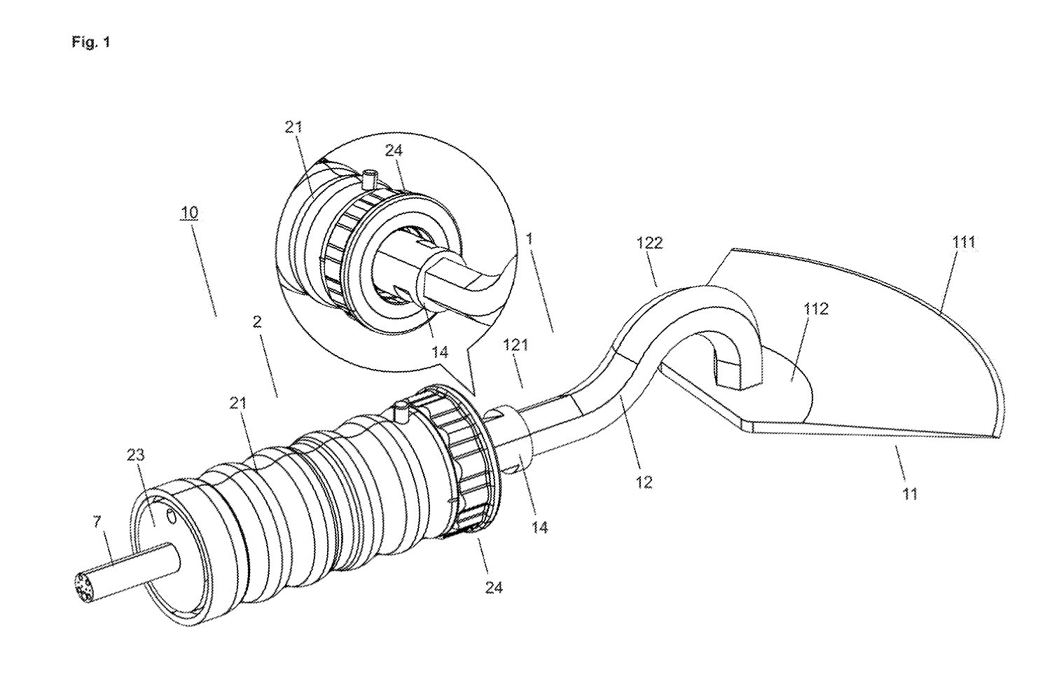

FIG. 1 an inventive hand tool 10 in a preferred embodiment, which comprises a housing part 2, in which a tool part 1 is held that comprises a coupling rod 12 that is connected on the front side to a blade 11;

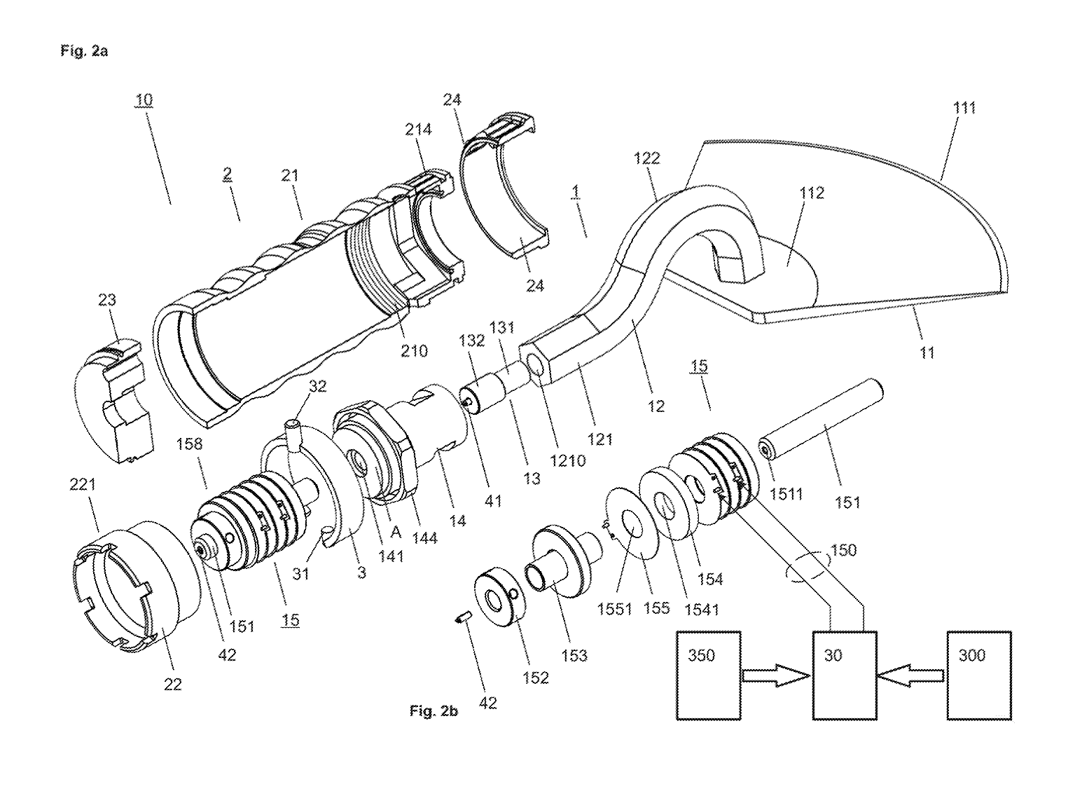

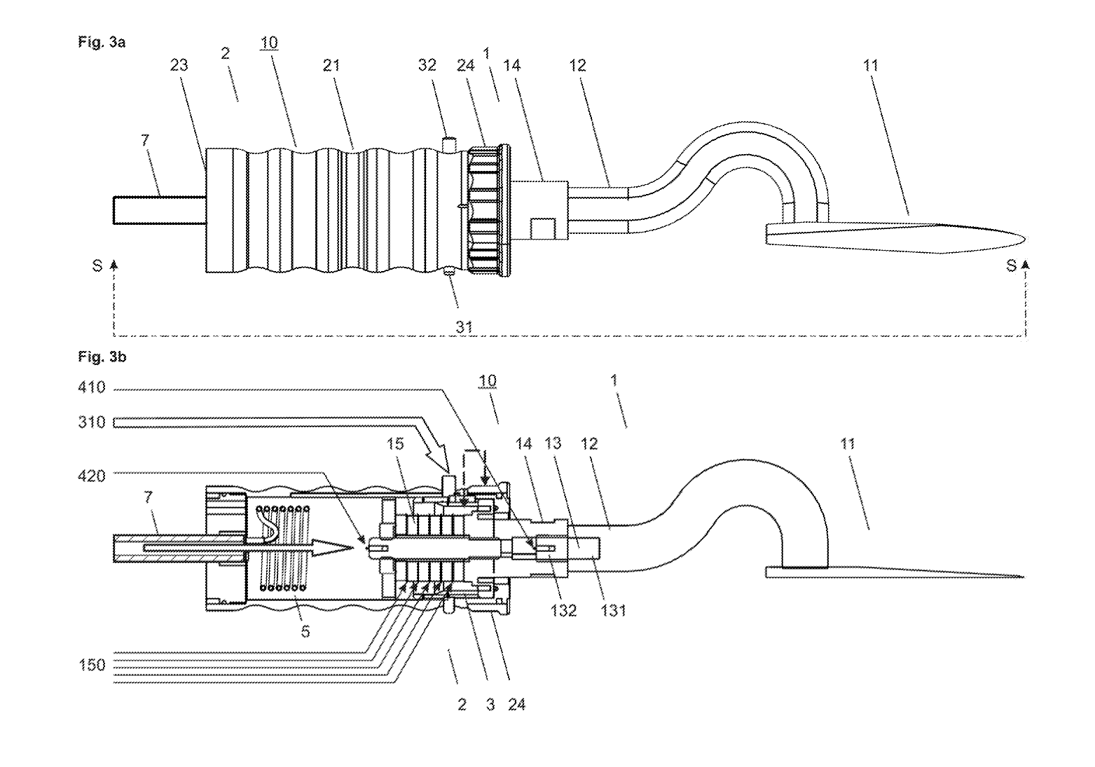

FIG. 2a the hand tool 10 of FIG. 1 in an explosion view with the housing part 2 cut along cutting line S-S of FIG. 3a, an ultrasonic transducer 15 with a transducer rod 151 that is connectable via a connecting cylinder 14 and a connecting bolt 13 to the proximal first rod member 121 of the coupling rod 12 and that is coaxially aligned thereto;

FIG. 2b the ultrasonic transducer 15 of FIG. 2a in an explosion view with the transducer rod 151, an insulation tube 153, annular piezo elements 154, annular contact plates 155 and a pressing element 152;

FIG. 3a a side view of the hand tool 10 of FIG. 1;

FIG. 3b a sectional view with a cut through the hand tool 10 along cutting line S-S shown in FIG. 3a;

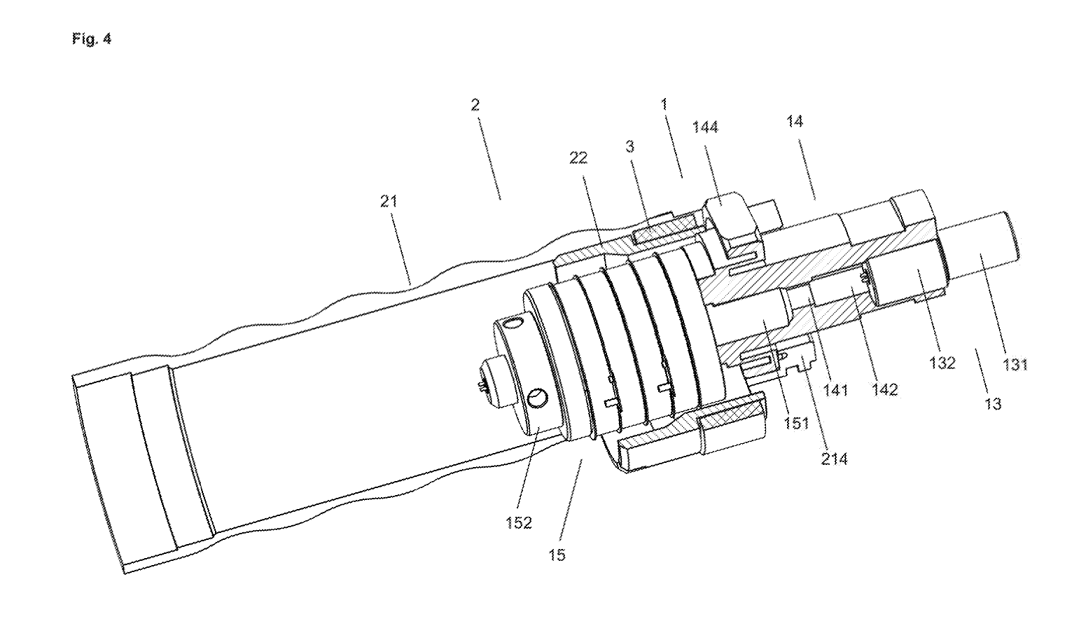

FIG. 4 a part of the hand tool 10 of FIG. 3a with a sectional view with a first cut along the cutting line S-S through the connecting cylinder 14 and the housing body 21 and with a second cut perpendicular thereto through a crown nut 22, with which the connecting cylinder 14 is pressed against an inner flange 214 provided at the front side of the housing body 21;

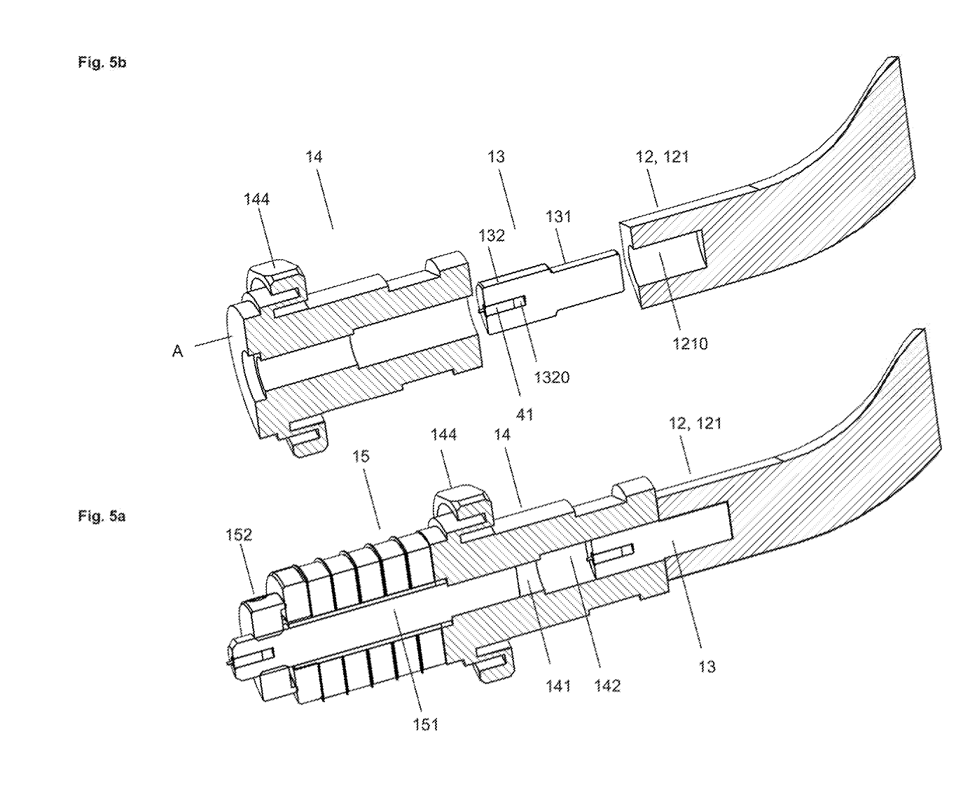

FIG. 5a a sectional view with a cut along cutting line S-S of FIG. 3a through the ultrasonic transducer 15 and the transducer rod 151 as well as the connecting cylinder 14 and the connecting bolt 13 that connects the connecting cylinder 14 to the first rod member 121 of the coupling rod 12;

FIG. 5b the connecting cylinder 14, the connecting bolt 13 and the first rod member 121 of the coupling rod 12 of the sectional view of FIG. 5a, which are released from one another;

FIG. 6a the hand tool 10 of FIG. 3a in a further preferred embodiment with a cut along cutting line S-S;

FIG. 6b the connecting cylinder 14 and the first rod member 121 of the coupling rod 12 of sectional view of FIG. 6a released from one another;

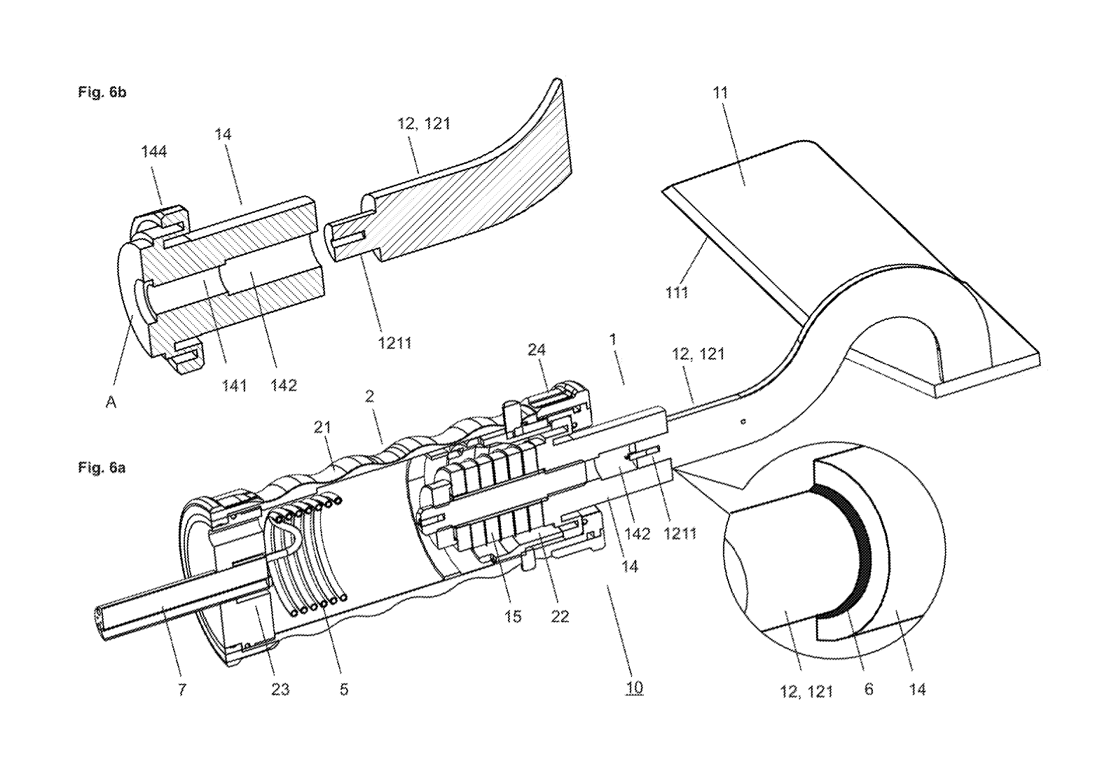

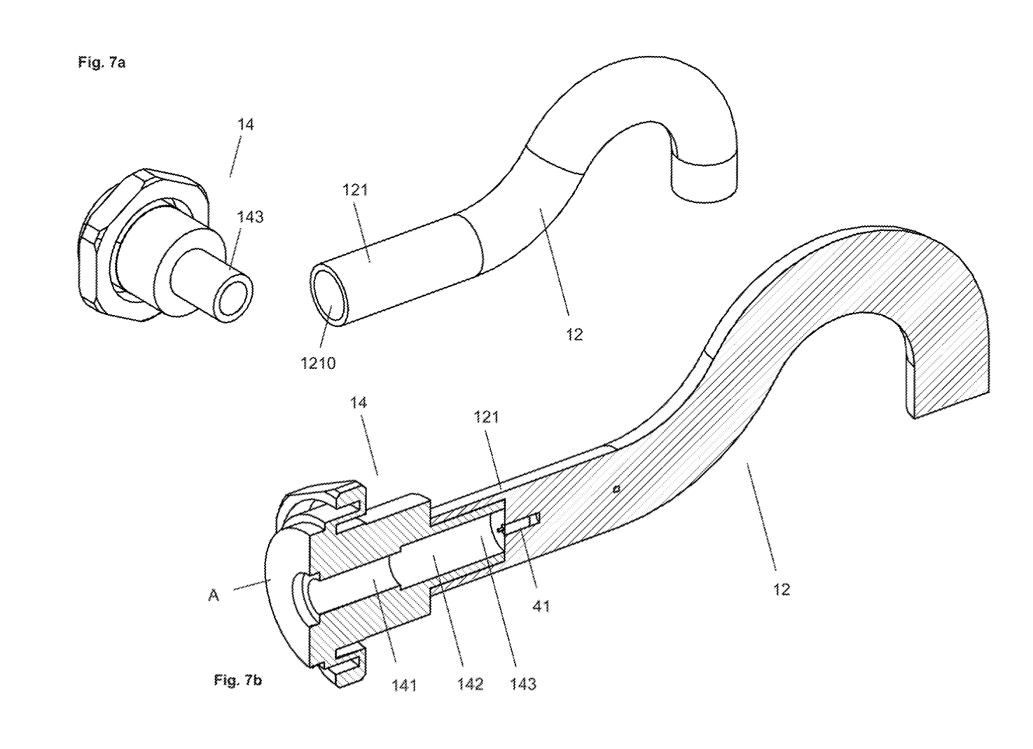

FIG. 7a a preferably designed connecting cylinder 14 and a coupling rod 12 matching thereto released from one another;

FIG. 7b in sectional view the connecting cylinder 14 and the coupling rod 12 of FIG. 7a connected thereto;

FIG. 8 the coupling rod 12 in a preferred embodiment, with a first rod member 121 forming the connecting cylinder 14 and with a second rod member 122 holding a blade 11 that is aligned in a plane perpendicular to the first rod member 121;

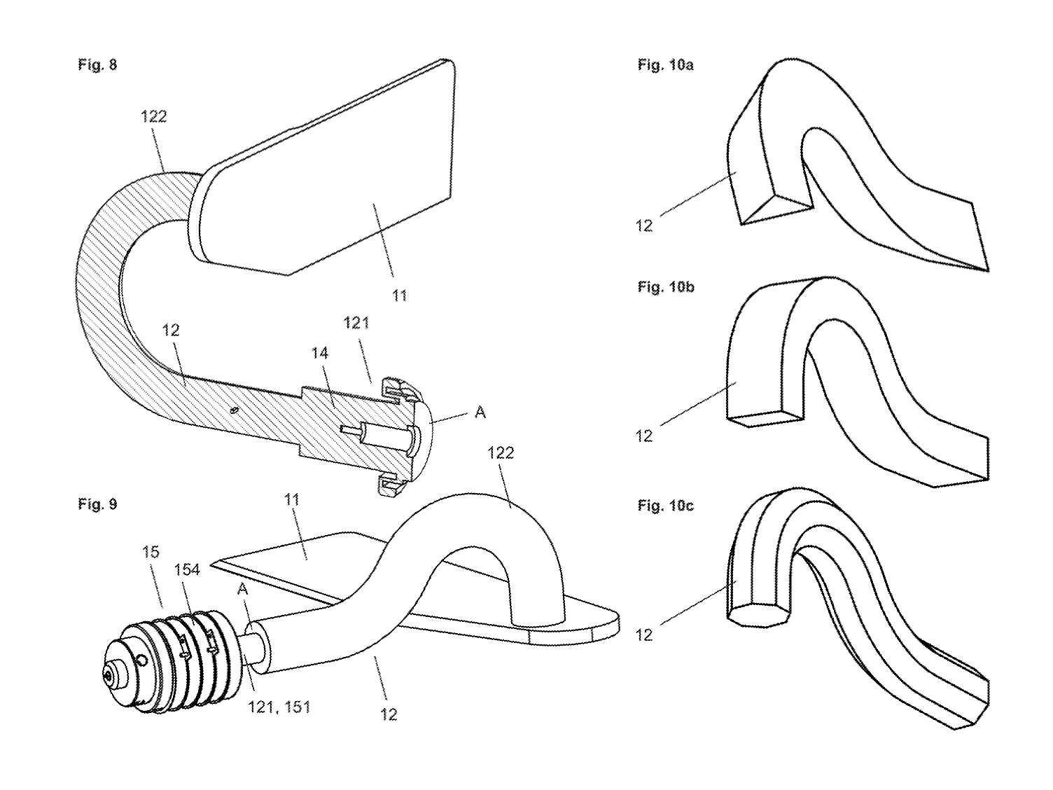

FIG. 9 the coupling rod 12 in a preferred embodiment with a first rod member 121 forming the transducer rod 151 and with a second rod member 122 holding a blade 11 that is aligned in a plane parallel to the first rod member 121, which exhibits a circular cross section;

FIG. 10a a coupling rod 12 with a triangular cross section;

FIG. 10b a coupling rod 12 with a square cross section; and

FIG. 10c a coupling rod 12 with an octagonal cross section.

FIG. 1 shows an inventive hand tool 10 in a preferred embodiment. The hand tool 10 comprises a tool part 1 that is held within a housing part 2, which comprises a hollow cylindrical housing body 21.

In a detailed view FIG. 1 shows that a connecting cylinder 14 is extending out of the housing body 21 and is connected to a first rod member 121 of a coupling rod 12, whose second rod member 122 stands perpendicularly on the back 112 of a blade 11. The blade 11 exhibits the form of a segment of a circle and comprises a cutting edge 111 that is extending along a circular line. The blade 11 can also have a different design and can form for example a part of a polygon.

The housing body 21 is equipped at the front side with a control ring 24 that can conveniently be turned for changing the mode of operation of the hand tool 10. E.g., an ultrasonic generator provided inside the housing part 2 can be switched on. E.g., suitable values for the frequency and/or the amplitude of the ultrasound signals or pre-programmed operation modes can be selected that have been evaluated for processing the goods. On the backside the housing body 21 closed by a terminating element 23. In this embodiment, the hand tool 10 is equipped with a connecting cable 7, via which a supply voltage or ultrasound signals are supplied to the hand tool 10. The terminating element 23 is preferably equipped with a connector, which is connectable to a cable 7, via which a supply voltage and/or data are transferable. E.g., with the supply voltage an accumulator can be charged. However, with the transferred data the hand tool can also be programmed in order to be adapted to a specific purpose of use. E.g., frequencies or frequency intervals are selected, which are suitable for processing specific goods.

The hand tool 10 has a compact structure and comprises, in spite of the relatively large tool part 1, a relatively small housing part 2 that can conveniently be held with one hand. Under the application of ultrasonic energy, the blade 11 allows easily and precisely cutting goods or finely atomising powdery goods that have been put onto the blade 11.

FIG. 2a shows the hand tool 10 of FIG. 1 in explosion view. The housing part 2 with the housing body 21, the annular control member 24 and the terminating member 23 are cut along the longitudinal axis. The tool part 1 comprises an ultrasonic transducer 15, which is shown in FIG. 2a as a unit and in FIG. 2b in explosion view.

The ultrasonic transducer 15 comprises six hollow cylindrical or annular piezo elements 154, which are separated from one another by five annular contact elements or contact plates 155. The piezo elements 154 exhibit a disk-shape and are provided with a transfer opening 1541. E.g., piezo elements 154 with a thickness in the range of 2 mm-8 mm are provided. The contact elements 155 are for example brass plates having a thickness in the range from 1/10 mm-½ mm and comprise also a transfer opening 1551. Furthermore, the contact elements 155 are provided with connecting contacts. The transfer openings 1541, 1551 are traversed by a transducer rod 151 and an insulation tube 153, which insulates the piezo elements 154 and the contact elements 155 against the metal transducer rod 151.

The transducer rod 151 comprises an opening 1511 at the front side and an external thread, on which a pressing element 152 is seated that is used for pressing the piezo elements 154 and the contact elements 155 against one another. In an opening 1511 provided at the front side of the transducer rod 151 a temperature sensor 42 is inserted, with which the temperature of the ultrasonic transducer 15 can be measured.

FIG. 2a shows further that the transducer rod 151 can be fixed by a press fitting or a threaded connection in a first cylinder opening 141 that is provided at the end piece of a connecting cylinder 14, which is facing the ultrasonic transducer 15, as shown in detail in FIG. 4. At this end piece of the connecting cylinder 14 a locating surface A is provided, which has approximately the same cross section as the piezo element 154 adjacent thereto. With the pressing element 152 the transducer block 158 that comprises the piezo elements 154 and the contact elements 155 lying in between can therefore be pressed against the locating surface A, in order to reach optimum coupling. Thereby, the transducer block 158 and the connecting cylinder 14, which are connected in a force locking manner and form locking manner, form a unit, via which the ultrasound waves are transferred optimally to the blade 11.

At the end piece, which is facing blade 11, the connecting cylinder 14 comprises a second cylinder opening 142, in which a second bolt member 132 of a connecting bolt 13 can be fixed by a press fitting or a threaded connection. In addition, the connecting bolt 13 comprises a first bolt member 131, which can be fixed by a press fitting or a threaded connection in a rod opening 1210 of the first rod member 121 of the coupling rod 12. The second rod member 122 of the coupling rod 12 extends along a curve perpendicular to the back 112 of the blade 11 and is connected with it in one piece, preferably by welding.

It can be seen that the elements of the transmission chain for the ultrasound signals are firmly connected with one another and with the compact structure of the tool part 1 a low loss transmission of the ultrasound signals to the blade can be reached. In preferred embodiments described below this transmission chain is further simplified and shortened, so that an even more compact structure of the tool part and a practically optimal transmission of the ultrasound signals can be reached.

The connecting cylinder 14 shown in FIG. 2a comprises an outer flange 144, which serves for mounting the tool part 1 within the housing body 21 that comprises an inner flange 214 at the front side. The housing body 21 further comprises an internal thread 210, into which a threaded element with an external thread 221, namely the shown crown nut 22 can be turned. With the crown nut 22 the outer flange 144 of the connecting cylinder 14 can be pressed against the inner flange 214 of the housing body 21, in order to fix the tool part 1 within the housing part 2. Between the inner flange 214 and the outer flange 144 preferably an elastic element is provided, which mechanically holds the two connected elements securely, but inhibits the transmission of ultrasonic energy.

FIG. 2a further shows a flexible printed circuit board 3 with electrical elements 31, 32, e.g. multi-coloured light emitting diodes that indicate the mode of operation of the hand tool 10. Hence, the control ring 24 can be turned until the light emitting diodes 31, 32 indicate that the desired mode of operation has been reached. The flexible printed circuit board 3, preferably a bendable insulated metal substrate IMS, is equipped with electrical and electronic modules, which preferably allow controlling and monitoring operation of the hand tool 10. Further, modules of the ultrasonic generator 30 can be arranged on the printed circuit board 3.

FIG. 2b shows that the ultrasonic generator 30 is connected via generator lines 150 to the connecting contacts of the contact elements 155, so that an alternating voltage in the ultrasound region can be applied to the installed piezo elements 154, which are deformed accordingly.

The ultrasonic generator 30 is connected to a power supply unit 300, which may be present in form of an accumulator or batteries, is also installed in the hand tool 10. Alternatively, a supply voltage can be supplied via connecting line 7, as shown in FIG. 1.

The ultrasonic generator 30 is also connected to a control unit 350, with which the ultrasonic generator 30 is controllable preferably such that ultrasound signals with a desired operating frequency and amplitude are delivered. Further, intervals can be programmed, with which the operating frequency is changed or alternated. As mentioned, the control unit 350 can be arranged on the flexible printed circuit board 3.

The flexible printed circuit board 3 is preferably bent cylindrically with a radius that is slightly smaller than the inner radius of the hollow cylindrical housing body 21. In this manner, a relatively large printed circuit board can be integrated with little space requirement inside the housing body 21.

FIG. 3a shows a side view of the hand tool 10 of FIG. 1 as well as a cutting line S-S.

FIG. 3b shows a sectional view with a cut through the hand tool 10 along the cutting line S-S shown in FIG. 3a. The elements of the tool part 1 and of the housing part 2 as well as the elements of the flexible printed circuit board 3, on which optionally the control unit 350 and the ultrasonic generator 30 are provided, have been described. Further shown are five generator lines 150 that are connected to the contact elements 155, two measurement lines 410 and 420 that lead to the first and to the second temperature sensor 41, 42, as well as further electrical lines 310. All lines 150, 310, 410 and 420, which are schematically shown, can lead to the control unit 350 and/or to the ultrasonic generator 30, which can be arranged on the flexible printed circuit board 3 or externally to the hand tool 10. Switches can further be provided with which the lines 150, 310, 410 and 420 can be interrupted or closed.

FIG. 3b further shows a cooling coil 5 through which a cooling agent can flow in order to transfer heat from the interior of the housing body 21 to the outside. In preferred embodiments the cooling coil 5 surrounds the ultrasonic transducer 15, so that its temperature is regulated to an ideal value and heat losses can be led away.

FIG. 4 shows a part of the hand tool 10 of FIG. 3a with a first cut along cutting line S-S through the connecting cylinder 14 and the housing body 21 and a second cut perpendicular thereto through the crown nut 22, with which the connecting cylinder 14 is pressed against the inner flange 214 provided at the front side of the housing body 21. The close coupling of the ultrasonic transducer 15, which by means of the pressing element 152, e.g. a pressing nut having an internal thread, is pressed against the connecting cylinder 14, is well visible.

FIG. 5a shows a sectional view with a cut along cutting line S-S of FIG. 3a through the ultrasonic transducer 15 and the transducer rod 151 as well as through the connecting cylinder 14 and the connecting bolt 13, which connects the connecting cylinder 14 with the first rod member 121 of the coupling rod 12.

FIG. 5b shows in the sectional view of FIG. 5a the connecting cylinder 14, the connecting bolt 13 and the first rod member 121 of the coupling rod 12 that are released from one another.

FIG. 6a shows the hand tool 10 of FIG. 3a in a further preferred embodiment with a cut along cutting line S-S. In this embodiment the connecting bolt 13 shown in FIG. 4 is not used. Instead at the first rod member 121 of the coupling rod 12 a rod bolt 1211 is provided, which is inserted into a front sided cylinder opening 142 of the connecting cylinder 14. The rod bolt 1211 is preferably connected to the connecting cylinder 14 by a press fitting and/or a threaded connection and/or a welded connection. The detailed view of FIG. 6a shows the front side of the connecting cylinder 14 having a welded seam 6 which connects the connecting cylinder 14 to the first rod member 121 of the coupling rod 12. By avoiding the connecting bolt 13 the transmission chain is reduced, wherefore a closer coupling of the ultrasonic transducer 15 to the sonotrode, i.e. the blade 11 results.

This example shows the alignment of the blade 11 in the kind of a kebab-knife with backward oriented cutting edge 111. The example shows that the inventive hand tool 10 allows advantageously executing any possible cutting movement by suitably aligning the blade 11.

FIG. 6b shows in the sectional view of FIG. 6a the connecting cylinder 14 and the first rod member 121 of the coupling rod 12 separated from one another.

FIG. 7a shows a preferred design of the connecting cylinder 14 and a coupling rod 12 matching thereto that are separated from one another. The connecting cylinder 14 comprises a hollow cylindrical connecting bolt 143, which can be inserted into a rod opening 1210 provided in the first rod member 121 of the coupling rod 12. This embodiment has the advantage that measurement lines can be guided up to the coupling rod 12 in order to contact e.g. a temperature sensor 41 or an ultrasound sensor or a piezo element that is installed in the rod opening 1210. Also in this embodiment, a close coupling of the ultrasonic transducer 15 to the blade 11 is present.

FIG. 7b shows in sectional view the coupling rod 12 of FIG. 7a that is connected to the connecting cylinder 14.

FIG. 8 shows a sectional view of a preferred embodiment of the coupling rod 12, whose first rod member 121 forms the connecting cylinder 14 and whose second rod member 122 holds a blade 11, which is aligned in a plane perpendicular to the first rod member 121. Hence, the first rod member 121 is designed at its end as connecting cylinder 14. Hence, the transducer rod 151 shown in FIGS. 2a, 2b and 4 can be connected directly to the coupling rod 12. Thereby, the transducer block 158 is pressed directly against the locating surface A provided at the first rod member 121, so that nearly optimal coupling results.

FIG. 9 shows a further preferred embodiment of the coupling rod 12, whose first rod member 121 forms the transducer rod 151 and whose second rod member 122 holds a blade 11, which is aligned in a plane parallel to the first rod member 121, which has a circular cross section. The first rod member 121 of the coupling rod 12 forms at its end also the transducer rod 151 that preferably comprises the same dimensions as the transducer rod 151 of FIG. 2a. Hence, in this embodiment of the invention the transducer block 158 with the piezo elements 154 is directly coupled to the coupling rod 12, wherefore a direct coupling without transmission losses is reached. Preferably, the cross section the piezo elements 154 and the cross section of the locating surface A provided at the coupling rod 12 are adapted to one another.

FIGS. 9, 10a, 10b and 10c show that the coupling rod 12 can comprise cross sections which are adapted to the operating frequencies and to the application.

FIG. 9 shows a coupling rod 12 with a circular cross section. FIG. 10a shows a coupling rod 12 with a triangular cross section. FIG. 10b shows a coupling rod 12 with a square cross section. FIG. 10c shows a coupling rod 12 with an octagonal cross section.

### REFERENCE LIST

1 tool part
10 tool
11 blade
111 cutting edge
112 back of the blade
12 coupling rod
121 first rod member
1210 rod opening
1211 rod bolt
122 second rod member
13 connecting bolt
131 first bolt member
132 second bolt member
14 connecting cylinder
141 first cylinder opening
142 second cylinder opening
143 cylinder bolt
144 outer flange
15 ultrasonic transducer
150 generator lines
151 transducer rod
1511 receiving bore
152 pressing element
153 insulation tube
154 piezo elements
1541 transfer opening in the piezo element
155 contact element
1551 transfer opening in the contact elements
158 transducer block
2 housing part
21 housing body
210 internal thread
214 inner flange
22 threaded element, crown nut
221 external thread
23 terminating element
24 control ring
3 flexible printed circuit board
30 ultrasonic generator
300 power supply unit
31, 32 electrical elements
310 electrical lines
350 control unit
41 first temperature sensor
410 first sensor line
42 second temperature sensor
420 second sensor line
5 cooling coil
6 welded seam
7 connecting cable

1. A hand tool with a tool part that is held in a hollow cylindrical housing body of a housing part and that comprises an ultrasonic transducer with at least one piezo element, which serves for delivering ultrasonic energy to a blade that is connected to the tool part, wherein a plurality of piezo elements are provided, which are separated from one another by contact elements and which comprise each a transfer opening which is traversed by a transducer rod that is connected, directly or indirectly, to a coupling rod that is connected in one piece to the blade and that a pressing element is provided that is connected to the transducer rod and that presses the piezo elements against a locating surface of an element which is connected, directly or indirectly, to the coupling rod and which mechanically couples the piezo elements with the coupling rod.

2. The hand tool according to claim 1, wherein the transducer rod is separated from the piezo elements by a insulation tube,
a) is a part of the coupling rod and is therefore connected in one piece with the coupling rod; or
b) is held at the front side by a press fitting or a threaded connection in a rod opening provided in the coupling rod; or
c) is held at the front side by a press fitting or a threaded connection in a first cylinder opening of a connecting cylinder that is connected to the coupling rod.

3. The hand tool according to claim 2, wherein the connecting cylinder
a) is part of the coupling rod and therefore connected to the coupling rod in one piece; or
b) comprises on the front side a second cylinder opening, in which a rod bolt that is provided on the coupling rod is held by a press fitting or a threaded connection; or
c) comprises on the front side a massive or hollow cylindrical cylinder bolt, which is held within the rod opening by a press fitting or a threaded connection; or
d) comprises on the front side a second cylinder opening, in which a first bolt member of a connecting bolt is held by a press fitting or a threaded connection and that in the rod opening of the connecting cylinder a second bolt member of the connecting bolt is held by a press fitting or a threaded connection.

4. The hand tool according to claim 2, wherein the coupling rod and the transducer rod or the coupling rod and the connecting cylinder are welded together.

5. The hand tool according to claim 1, wherein the locating surface is an annular ring area that is provided on the end piece of the connecting cylinder or of the coupling rod, which is facing the ultrasonic transducer, and wherein the coupling rod comprises a circular, triangular, rectangular or square cross section.

6. The hand tool according to claim 2, wherein in the rod opening of the coupling rod and/or in an opening of the connecting bolt and/or in a back-sided opening in the transducer rod a temperature sensor is located.

7. The hand tool according to claim 1, wherein the piezo elements, which are pressed against one another, have a hollow cylindrical design or an annular design and form a cylindrical transducer block and that the pressing element comprises an internal thread, that is engaged in an external thread of the transducer rod.

8. The hand tool according to claim 2, wherein the transducer rod or the connecting cylinder or the coupling rod are provided with or connected to an outer flange, which is held by an inner flange that extends into the cross-section of the hollow cylindrical housing body.

9. The hand tool according to claim 8, wherein the housing body comprises an internal thread, which holds a threaded element that process the outer flange against the inner flange.

10. The hand tool according to claim 1, wherein a flexible printed circuit board is provided, which at least partially encloses the transducer block or the connecting cylinder and which is equipped with the electronic modules and electrical switching elements that serve for controlling the tool.

11. The hand tool according to claim 10, wherein the housing body is surrounded by a rotatable control ring, with which the electrical switching elements can be operated.

12. The hand tool according to claim 1, wherein a local power supply unit is provided or that electrical energy can be supplied via a connecting cable and that a ultrasonic generator is enclosed in the housing part or that the hand tool is connectable to an ultrasonic generator.

13. The hand tool according to claim 1, wherein a cooling coil is provided within the housing body, through which a cooling agent is guidable.

14. The hand tool according to claim 1, wherein the coupling rod is curved and stands with the front sided end piece end piece perpendicularly on the back of the blade.

15. The hand tool according to claim 1, wherein the cutting edge of the blade is directed forwards, backwards or to the side
